(19) United States
(12) Patent Application Publication
(10) Pub. No.: US 2026/0247477 A1
(43) Pub. Date: Aug. 20, 2026

(54) METHODS FOR DISCONTINUOUS CELL TRANSMISSION AND RECEPTION AND USER EQUIPMENT DISCONTINUOUS RECEPTION

(71) Applicant: INTERDIGITAL PATENT HOLDINGS, INC., Wilmington, DE (US)

(72) Inventors: Faris Alfarhan, Montreal (CA); Paul Marinier, Brossard (CA); Jaya Rao, Montreal (CA); Ananth Kini, Conshohocken, PA (US); Erdem Bala, East Meadow, NY (US); Moon IL Lee, Melville, NY (US)

(73) Assignee: INTERDIGITAL PATENT HOLDINGS, INC., Wilmington, DE (US)

(21) Appl. No.: 19/156,227

(22) PCT Filed: Feb. 13, 2024
(86) PCT No.: PCT/US2024/015515

§ 371 Date: Aug. 13, 2025

Related U.S. Application Data
(60) Provisional application No. 63/445,030, filed on Feb. 13, 2023.

(51) Int. Cl. H04W 76/28

(52) U.S. Cl. CPC H04W 76/28

(57) ABSTRACT

A method performed by a wireless transmit/receive unit (WTRU) includes receiving a cell discontinuous transmission (cell-DTX) configuration including active and inactive durations for the received cell-DTX configuration, receiving a first, a second, and a third connected WTRU DRX (C-DRX) cycle configurations, including an ON duration, periodicity, and start offset, and receiving signaling indicating that the cell-DTX configuration is activated in a serving cell of the WTRU. Thereafter, activating the third C-DRX cycle configuration associated with the activated cell-DTX configuration based on the signaling that the cell-DTX configuration is activated.

### CROSS REFERENCE TO RELATED APPLICATIONS

This application claims the benefit of U.S. provisional patent application No. 63/445,027 filed 13 Feb. 2023, which is incorporated by reference herein in its entirety.

### BACKGROUND

3GPP RAN has concluded a study item on network energy savings for Rel-18. The motivation is to study enhancements enabling the network to minimize its power consumption from transmission and reception. Such minimization is beneficial for reducing operational costs and environmental sustainability. The study item was approved and resulted in a new Rel-18 work item on network energy saving.

Compared to earlier systems, the design of NR of Rel-15 is very efficient from the perspective of minimizing transmissions from the network when there is no data. For example, always-on cell-specific reference signal (CRS) is not used in NR. However, there is still potential for energy consumption reduction.

For example, the network still consumes energy when not transmitting from other activities such as baseband (digital) processing for reception or beamforming. Such “idle” power consumption is not negligible in dense networks even when no UE is served during a given period. If the network could turn off these activities when not transmitting to a UE, energy consumption could be reduced.

Unlike LTE, NR does not require transmission of always-on synch or reference signals and supports adaptable bandwidth and MIMO capabilities. While initial work in R18 is expected to not impact legacy UEs, it's anticipated that such adaptation of network resources will enable greater efficiency in operating newer deployments and later generations.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 depicts an adaptation of connected mode discontinuous reception (C-DRX) cycle and inactivity timer in accordance with features of the disclosure;

FIG. 3 depicts an adaptation of On Duration/offset in accordance with features of the disclosure;

FIG. 4 depicts an adaptation of operation of a Discontinuous Reception Hybrid Automatic Repeat Request Round Trip Time (DRX HARQ RTT) uplink (UL) timer in accordance with features of the disclosure;

FIG. 5 depicts an adaptation of operation of a DRX HARQ RTT downlink (DL) timer in accordance with features of the disclosure; and

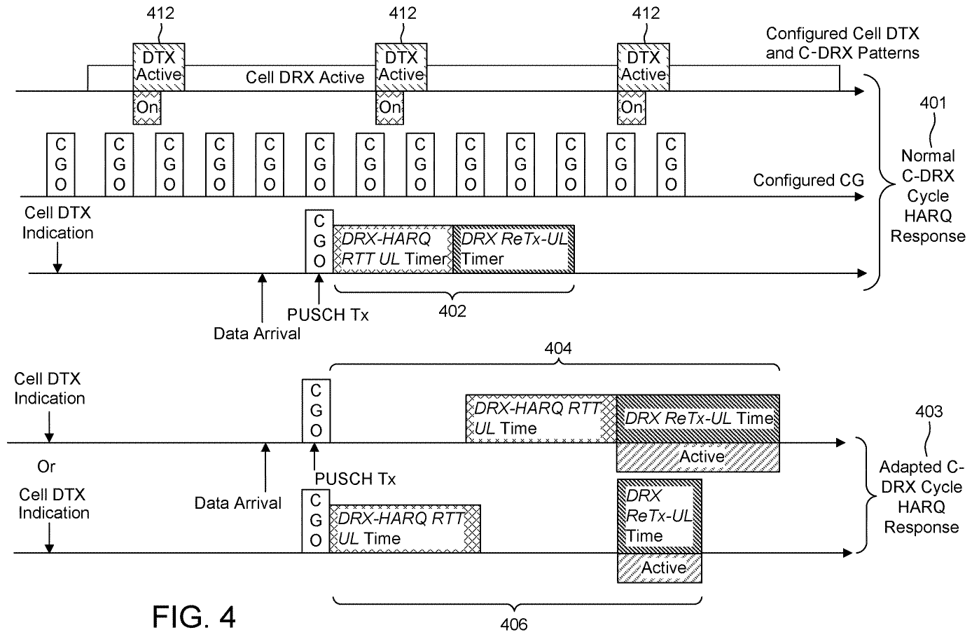

FIG. 4 depicts a flow diagram in accordance with features of the disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

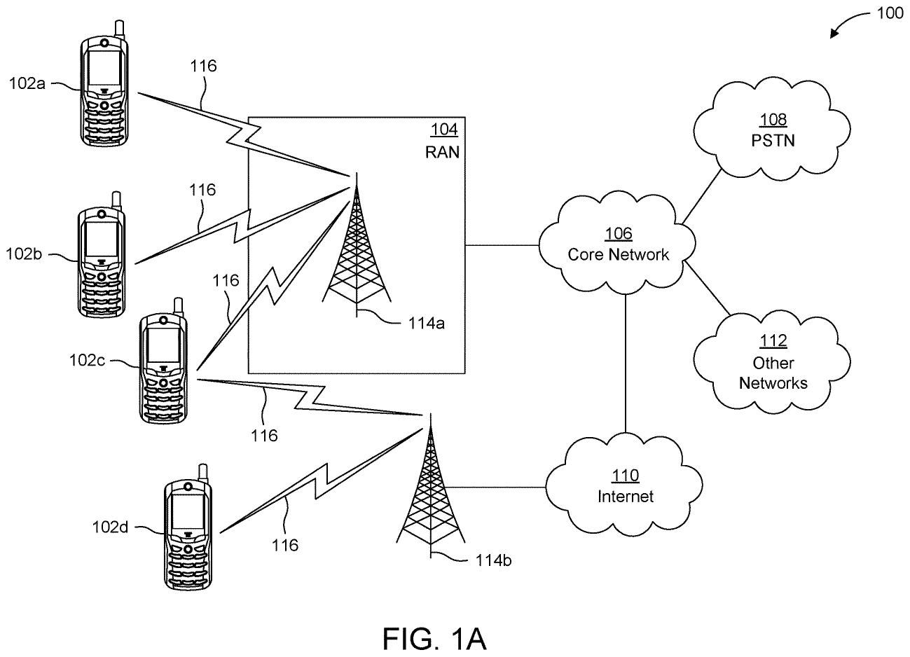

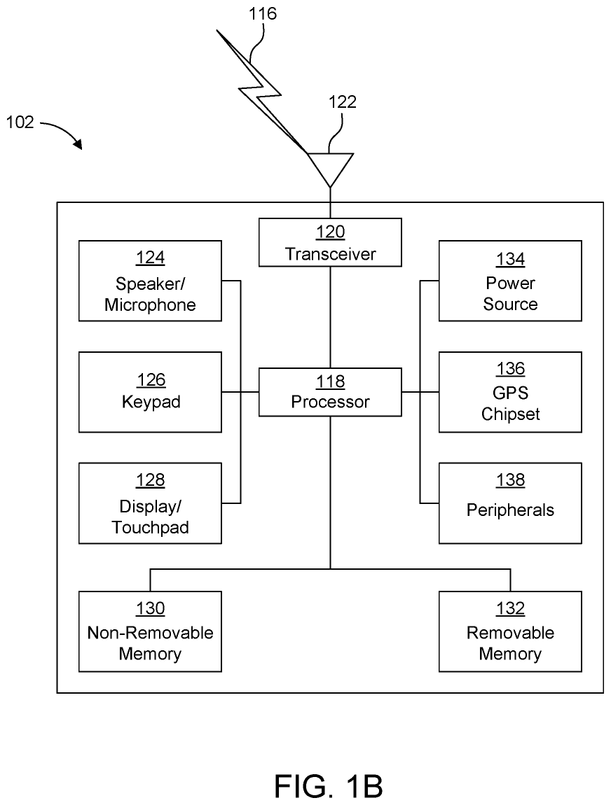

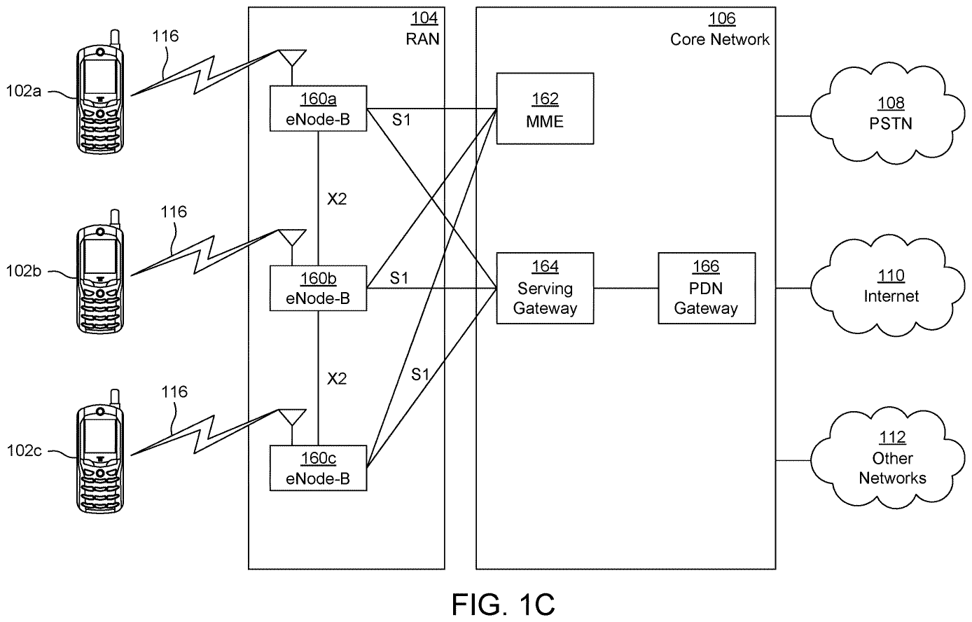

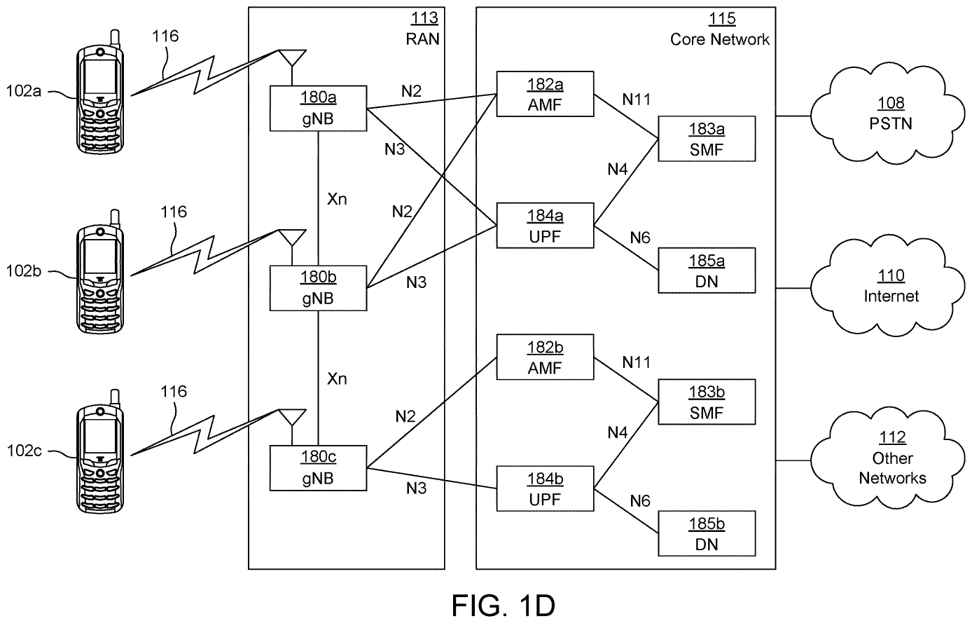

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANS (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

### Terminology

The following terminology is used and can be assumed through the description below.
1. CSI: Channel state information, which may include at least one of the following: channel quality index (CQI), rank indicator (RI), precoding matrix index (PMI), an L1 channel measurement (e.g. reference signal received power (RSRP) such as L1-RSRP, or signal-to-interference-plus-noise ratio (SINR)), CSI Reference Signal (CSI-RS) resource indicator (CRI), synchronization signal/physical broadcast channel (SS/PBCH) block resource indicator (SSBRI), layer indicator (L1) and/or any other measurement quantity measured by the UE from the configured CSI-RS or SS/PBCH block.
2. UCI: Uplink control information, which may include: CSI, Hybrid Automatic Repeat Request (HARQ) feedback for one or more HARQ processes, Scheduling request (SR), Link recovery request (LRR), configured grant UCI (CG-UCI) and/or other control information bits that may be transmitted on the physical uplink control channel (PUCCH) or physical uplink shared channel (PUSCH).
3. Channel conditions: any conditions relating to the state of the radio/channel, which may be determined by the UE from: a UE measurement (e.g., L1/SINR/RSRP, CQI/modulation coding scheme (CQI/MCS), channel occupancy, Received Signal Strength Indicator (RSSI), power headroom, exposure headroom), L3/mobility-based measurements (e.g. RSRP, Reference Signal Received Quality (RSRQ), s-measure), an Radio Link Monitoring (RLM) state, and/or channel availability in unlicensed spectrum (e.g. whether the channel is occupied based on determination of an listen before talk (LBT) procedure or whether the channel is deemed to have experienced a consistent LBT failure).
4. Physical random access channel (PRACH) resource: a PRACH resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random access procedure.
5. A property of scheduling information (e.g., an uplink grant or a downlink assignment) may include of at least one of the following: a frequency allocation; An aspect of time allocation, such as a duration; A priority; A modulation and coding scheme; A transport block size; A number of spatial layers; A number of transport blocks to be carried; A transmission configuration indication (TCI) state or sounding reference signal (SRS) resource indicator (SRI); A number of repetitions; Whether the grant is a configured grant type 1, type 2 or a dynamic grant.
6. An indication by downlink control information (DCI), or an indication, may include at least one of the following: An explicit indication by a DCI field or by radio network temporary identifier (RNTI) used to mask cyclical redundancy check (CRC) of the physical downlink control channel (PDCCH). An implicit indication by a property such as DCI format, DCI size, Coreset or search space, aggregation level, identity of first control channel resource (e.g., index of first control channel element (CCE)) for a DCI, where the mapping between the property and the value may be signaled by radio resource control (RRC) or medium access control (MAC). An explicit indication by a downlink (DL) MAC control element (CE).

In the description below, the terms network availability state, cell discontinuous transmission (DTX) mode/configuration, or Network Energy Savings (NES) state may be used interchangeably.

### Cell Discontinuous Transmission (DTX) and Cell Discontinuous Reception (DRX)

The gNB can currently use reduced downlink transmission/uplink reception activity without an explicit cell DTX/DRX pattern with restrictions due to UE DRX configurations and any configured transmission/reception, e.g., common channels/signals. Currently connected mode DRX (C-DRX) is configured per UE. The alignment of the DRX cycles or offsets for different UEs can be done only via RRC. During UE DRX off period, the UE does not expect to monitor PDCCH, but it is allowed to initiate UL transmission according to the configured resources (e.g. using PUCCH, random access channel (RACH), scheduling request (SR), or CG-PUSCH). Aligning/Omitting of DRX patterns across multiple UE's can be achieved via gNB implementation.

Cell DTX/DRX aims at providing mechanisms informing UE whether the cell stays inactive. This may include enhancements to UE DRX configuration, e.g. to align/omit DRX cycles or start offsets of DRX, for UEs in connected mode or idle/inactive mode, potentially allowing longer opportunities for cell inactivity. During a cell DTX/DRX, the cell may have no transmission/reception or only keep limited transmission/reception. For example, the cell does not need to transmit or receive some periodic signals/channels, such as common channels/signals or UE specific signals/channels.

Cell DTX/DRX is applied to at least UEs in RRC_CONNECTED state. A periodic Cell DTX/DRX (i.e., active and non-active periods) can be configured by gNB via UE-specific RRC signaling per serving cell. Cell DTX/DRX mode can be activated/de-activated via dynamic L1/L2 signaling and UE-specific RRC signaling. Both UE specific and common L1/L2 signaling can be considered for activating/deactivating the Cell DTX/DRX mode. Cell DTX and Cell DRX modes can be configured and operated separately (e.g., one RRC configuration set for DL and another for uplink (UL)). Cell DTX/DRX can also be configured and operated together. At least the following parameters can be configured per Cell DTX/DRX configuration: periodicity, start slot/offset, on duration. In one realization, Cell DTX indication could also be part of system information (SI) update or system information block (SIB) signaling. There can be a common time for all UEs to determine cell DTX status.

### Network Availability States/Cell DTX Mode/NES States

The UE may determine whether it can transmit or receive on certain resources depending on a network availability state, which implies the gNB's power savings status. An availability state may correspond to a network energy savings state, a cell DTX mode, a cell DRX mode, and/or a gNB activity level. An availability state can be uplink or downlink specific, and may change from symbol to symbol, slot to slot, frame to frame, or on longer duration granularity. The availability state may be determined by the UE or indicated by the network. An availability state can be, for example, “On”, “DL and UL active”, “UL only active”, “off”, “reduced Tx power”, “dormant”, “micro sleep”, “light sleep”, or “deep sleep”. Such states can be abstracted by network (NW) configuration parameters and/or values, and dynamic indication may point to the active availability state (e.g. by DCI or MAC CE signaling). The “Off” availability state may imply that the gNB's baseband hardware is completely turned off. The “sleep” availability state may imply that the gNB wakes up periodically to transmit certain signals (e.g. presence signals, synchronization, or reference signals) or receive certain UL signals. In some availability states, some DL or UL resources are not available during certain periods of time, and this enables the network to turn off baseband processing and other activities. Some measurement resources (e.g. synchronous signal blocks (SSB) s or CSI-RS) may only be made available in certain availability states, including: RLM, beam failure detection (BFD), Radio Resource Management (RRM) measurements, CSI-RS feedback configuration, and/or a different power offset for CSI feedback. Under certain conditions, the UE may further transmit a request to the network (wake-up request) to modify the availability state to a state for which resources that would satisfy UE requirements are available.

The UE may determine an availability state from reception of availability state indication from e.g. by L1/L2 signaling (e.g. a group common DCI or indication), or implicitly determine it form the reception of periodic DL signaling- or lack thereof.

The UE may determine if a resource is available for transmission/reception and/or measurements for the determined network availability state if it is applicable in the active availability state. In addition, the UE may also adapt its active C-DRX cycle, active spatial elements (e.g. antenna or logical ports), active Transmission/Reception Point (TRP) s, paging occasions as a function of the signaled or determined availability state. The UE may be configured with one or more sets of NES transmission and/or reception parameters per availability state, e.g. by broadcast or dedicated configuration signaling. The UE may apply the NES parameter set according to the determined or signaled availability state. The UE may apply one or more applicable configurations depending on the determined NES state. A set of NES parameter may include: a number of antenna ports, a C-DRX configuration, a measurement configuration (e.g. for RRM, RLM, and/or BFD), CSI feedback, a CSI-RS configuration, an SSB configuration, channel occupancy (CHO) or mobility candidates, a set of active TRPs.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, or a range of frequencies within a bandwidth part. For example, when an NES state changes in a cell, the UE may receive an availability state change indication indicating that this change is just for that cell, for all cells at the same frequency, or/and same radio access technology (RAT).

The UE may consider the active availability state associated with a cell, carrier, TRP, or frequency band to be “Off”, “Deep sleep”, or “Micro sleep” after reception of a DL signaling that changes the cell's or TRP's availability state. For example, the UE may receive a turn off command on broadcast signaling, RRC signaling, DCI (e.g. a group common DCI), or a DL MAC CE (e.g. indication part of PDSCH). The UE may determine an availability state from reception of availability state indication from e.g. by L1/L2 signaling (e.g. a group common DCI or indication) or broadcast signaling associated with an availability state. For example, an availability state change indication could also be part of SI update or SIB signaling (e.g. in a separate SIB that is not read by legacy UEs). There can be a common time for all UEs in the cell to determine availability state status.

The UE may implicitly assume a certain availability state associated with a cell, carrier, TRP, or frequency band (e.g. “Off, “deep sleep”, “micro sleep” or dormant”) from: reception of a paging message (e.g. paging DCI, paging PDSCH, or a paging related signal, i.e. Paging Early Indication (PEI)), The gNB DTX status (whether the gNB is in active time or an associated activity timer is running), lack of detection of a presence indication, the availability state of an associated cell, or measured channel conditions(s) being below- or a above-a threshold.

The UE may be configured to monitor an indication that may characterize the level of network activity (e.g. an availability state). The network activity may be associated with a gNB and/or a cell. The UE may assume the same availability state for all cells part of the same gNB, e.g. cells of the same MAC entity. The network activity indication (e.g. the presence indication) may include a channel (e.g., a PDCCH) and/or a signal (e.g., a sequence). The activity indication or the NES state change indication/command may indicate the level of activity the UE may expect from the associated gNB and/or cell, e.g., reduced activity. The activity indication may contain activity information of other gNBs/cells. The activity indication may be a PDCCH containing group common signaling. For example, the NW may transmit a group common DCI to a group of UEs (e.g. UEs in the serving cell) indicating a change of an activity state or activity level in UL and/or DL. The CRC of the PDCCH may be scrambled with a dedicated “activity indication RNTI or an NES-RNTI”. A UE may be configured with at least one search space associated with the monitoring occasions of the activity indication PDCCH. The indication may include a go-to-sleep signal, e.g., a predefined sequence. When UE detects this sequence, UE may expect a reduced activity level over a specific time duration. The UE may activate C-DRX for the period of time indicated. Alternatively, two sequences may be used to indicate regular activity and reduced activity.

The signaling within the PDCCH or the activity indication may contain at least one of the following:
1. Expected activity level of the associated gNBs/cells over a specific time interval (e.g. an availability state). The activity levels may be predetermined and/or configured and may, for example, include of regular and reduced activity. The signaling may indicate the activity level. For example, bit “1” may indicate regular activity and bit “0” may indicate reduced activity.
2. For each activity level (e.g. availability state), transmission and reception attributes may be defined. For example, during reduced activity, UE may not be expected to monitor certain PDCCH search spaces (including all synchronization signals (SSs)), and/or receive a certain type of PDSCH (including all PDSCH), and/or transmit PUCCH/PUSCH, and/or perform certain measurements. The UE may start or stop monitoring PDCCH and/or TCI states associated with determined NES state, including PDCCH resources or TCI states associated with (de) activated TRPs or spatial elements.
3. A set of configurations may be associated with an activity level and may be used/applied when that activity level is indicated (e.g. an NES parameter set). For example, SS configurations, CSI reporting configurations, indices of transmitted SSBs, etc. Each set of configurations may have an attribute associated with an activity level. For example, a tag that can be set to “reduced activity”.
4. The time interval over which an activity level is assumed may be signaled in the PDCCH or part of the activity indication.
   a. The time interval may be indicated using a bitmap where each bit in the bitmap may be associated with a specific duration, e.g., a slot or a frame. For example, bit “1” may indicate regular activity and bit “0” may indicate reduced activity on an associated frame.
   b. The time interval may be indicated with a start time and length of interval. The start time may be defined; for example, it may be determined by adding a fixed offset to the time the indication is received. The length of the interval may be configured or signaled in the indication PDCCH.
5. The time interval over which an activity level is assumed may be predetermined. The UE may assume an interruption delay (or more generally a time till the NES state changes) after the NES state change command reception (e.g. after the last symbol or slot on which the command was received). The interruption time can be in absolute time, a number of symbols, or a number of slots.

The UE may determine that an uplink or downlink resource or signal is available for transmission/reception and/or measurements for the determined network availability state if it is applicable in the active availability state. The UE may determine that a subset of measurement resources and/or signals (e.g. SSBs, CSI-RS, tracking reference signal (TRS), positioning reference signal (PRS)) are not applicable in certain availability states. The UE may determine that a subset of uplink or downlink resources (e.g. PRACH, PUSCH, PUCCH) are not applicable in certain availability states. The UE may transmit some uplink signals only in a subset of NW availability states (e.g. SRS, pSRS, PRACH, UCI).

### Issues

Cell DTX and cell DRX can be configured separately and may not be aligned with each other or with the UE C-DRX, which may have impact on the UE. In a given On duration, the network may receive only, transmit only, and/or perform both. UE UL transmissions during cell DRX thus cause unnecessary interference in the network.

Many C-DRX timers that dictate “Active time” start after UL transmissions (e.g. after SR, RACH, or CG transmissions) though the serving cell may in Cell DTX in the downlink direction only. Current specifications require the UE to perform unnecessary retransmissions of such UL signals, simply because the NW didn't get the chance to reply yet. Further, the UE is considered in C-DRX Active time after such transmissions, thus wasting battery. How to ensure the UE C-DRX active time and Cell DTX active periods are aligned? How to ensure the UE is not monitoring PDCCH when not needed? How to ensure the UE is not retransmitting UL signals even if the first transmission was received correctly but NW didn't get the chance to reply yet?

Further, UE DRX parameter and timers (e.g. On duration and other timers) may not be aligned with the active cell DTX/cell DRX), thus causing unnecessary battery consumption and unwarranted monitoring of DL channels. Another concern is that some SR occasions occur while the network is not receiving due to being in network energy saving state. Retransmission of SR may be wasteful of resources.

### Issue Addressed

The following are proposed solution topics addressing the above issues. These solution topics are further discussed in the detailed descriptions that follow.

1. Adaptation of UE C-DRX with Cell DTX/DRX

The UE may be configured with a first and second DRX configurations. The second DRX cycle may be used while a cell DTX configuration is activated in addition to the first DRX cycle. This ensures that the UE is monitoring the PDCCH while the network is not sleeping. Further discussion is in the section below entitled “Adaptation of UE C-DRX with Cell DTX/DRX”.

### Definitions

The following are definitions or aspects of technologies that may be common to the several descriptions of embodiments/solutions to the issues defined hereinabove.
1. Cell DTX active period: duration of time over which a configured cell DTX pattern is active (e.g. periods of time during an On Duration periods of a Cell DTX pattern). UE may be predefined and to monitor PDCCH and other DL signals and channels during such time. This may be applicable only after a cell DTX configuration has been indicated by the NW to be activated.
2. Cell DTX inactive period: duration of time over which a configured cell DTX pattern is not active/inactive (e.g. periods of time outside periodic On Duration periods of a Cell DTX pattern). This may be applicable only after a cell DTX configuration has been indicated by the NW to be activated.
3. Cell DRX active period: duration of time over which a configured cell DRX pattern is active (e.g. periods of time during an On Duration periods of a Cell DRX pattern). UE may be predefined to be allowed to transmit UL signals and on UL channels during such time. This may be applicable only after a cell DRX configuration has been indicated by the NW to be activated.
4. Cell DRX inactive period: duration of time over which a configured cell DRX pattern is not active/inactive (e.g. periods of time outside periodic On Duration periods of a Cell DRX pattern). This may be applicable only after a cell DRX configuration has been indicated by the NW to be activated.
5. Activated Cell DRX/DTX: A state of a configured cell DRX or Cell DTX pattern, where such state has been activated by L1/L2 DL signaling, RRC (re)-configuration, and/or cell common configurations, and has not been de-activated.
6. De-activated Cell DRX/DTX: A state of a configured cell DRX or Cell DTX pattern, where such state has been deactivated by L1/L2 DL signaling, RRC (re)-configuration, and/or cell common configurations.
7. Link between availability state and Cell DTX/DRX. Herein, both terms may be used interchangeably. The UE may determine a cell DTX state implicitly from a determined active availability state, and vice-versa. The UE may determine a cell RTX state implicitly from a determined active availability state, and vice-versa.
8. The terms downlink configured grant (DL CG)” and Semi-persistent scheduling “(SPS)” may be used interchangeably herein.

A Cell DTX configuration may determine the Cell DTX active period as set of Cell DTX occasions. Such set may be parameterized by at least one of a duration between the start of successive occasions (Cell-DTX-cycle), an offset (Cell-DTX-offset) and a duration (Cell-DTX-duration) for each Cell DTX occasion. For example, such parameters may be expressed in units of subframes (or milliseconds) in the same way as the long UE DRX cycle. In such case, a Cell DTX occasion may consist of a time period that starts in a subframe satisfying [SFN x 10+subframe number] modulo (Cell-DTX-cycle)=(Cell-DTX-offset), where SFN is a system frame number, and ends (Cell-DTX-duration) later.

The Cell DTX configuration may also include a slot offset with respect to the start of the subframe in which a Cell DTX occasion starts. At least one parameter of the Cell DTX configuration may be signaled by RRC, MAC CE and/or DCI (UE-specific or UE-group common).

The UE may be predefined or configured per Cell DTX and/or a Cell DRX configuration with one of the following parameters and behaviors:
1. One or more applicable configured grant or SPS configuration. For example, the UE may activate such configured grants upon activation of the cell DTX and/or cell DRX configuration. The UE may be configured per configured grant with whether the configured grant has priority over the configured cell DTX and/or cell DRX pattern (e.g. whether the UE can transmit or receive on a UL or DL CG during a cell DRX or cell DTX inactive period, respectively).
2. Whether the UE should monitor PDCCH for dynamic grants or dynamic DL assignments during the cell DTX inactive period.
3. Whether the UE is allowed to transmit on dynamic grants or configured grants
4. PRACH resources or PRACH resource configuration that may be—or may not be—applicable during a Cell DRX inactive period, or if a cell DRX configuration is activated.
5 SR/PUCCH resources or SR/PUCCH resource configuration that may be—or may not be—applicable during a Cell DRX inactive period, or if a cell DRX configuration is activated.
6. CSI-reporting or CSI-reporting resource configurations that may be—or may not be—applicable during a Cell DRX inactive period, or if a cell DRX configuration is activated.
7 SRS resources or SRS resource configuration that may be—or may not be—applicable during a Cell DRX inactive period, or if a cell DRX configuration is activated.

The UE may be configured with multiple cell DRX and/or cell DTX configurations simultaneously in a given serving cell. The UE may be configured with a primary or a default cell DTX and/or cell DRX configuration, which the UE may apply by default. Upon reception of signaling activating one cell DTX and/or cell DRX configuration, the UE may deactivate another one (or all other ones). Upon reception of signaling deactivating one cell DTX and/or cell DRX configuration, the UE may activate another one or activate a default cell DTX/DRX configuration. Upon expiry of a timer, the UE may fallback to the default cell DRX and/or cell DTX configuration. The UE may reset such timer upon reception of DL signaling or data or an indication from the NW to remain in a given non-default cell DTX or cell DRX state.

### Initial Common Solution Components

Cell DTX can be assumed/configured by the UE per channel, DL signals (e.g. including PDCCH, RS, PDSCH etc), per cell, per channel type, and/or per signal type. Cell DRX can be assumed/configured by the UE per channel, UL signals (e.g. PRACH, PUSCH, PUCCH, SRS, wake up signal (WUS)), or per cell, per channel type, and/or per signal type.

Whether the UE prioritizes a configured Cell-DRX pattern vs. the UE-specific channel/signals configuration can be predefined, configured, or determined as a function of: the UE capability, data priority or latency, and/or the control signaling/info type. One example of a UE Signal or channel that may have priority to override a configured cell DRX pattern is a CG transmission, SR transmission, or transmission of a cell WUS.

Adaptation of UE C-DRX with Cell DTX/DRX

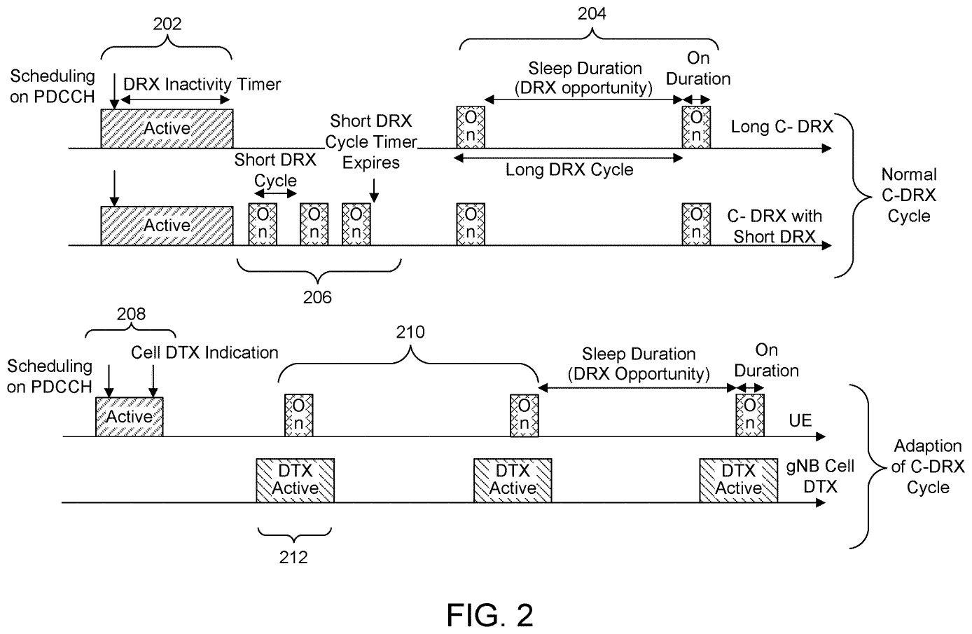

FIG. 2 depicts one view of the usual C-DRX cycle showing the condition 202 where an On-Duration DRX cycle opportunity is extended via a DRX Inactivity Timer upon receipt of a Scheduling on a PDCCH. In the first example DRX cycle 204, a long C-DRX cycle is shown. In the second example DRX cycle, 206, a short DRX cycle is shown in response to the scheduling PDCCH. In an adaptation of a C-DRX cycle and inactivity timer, at 208, a scheduling PDCCH is received in an On-Duration, a DRX-Inactivity Timer is started, and a Cell DTX indication from the network is received. The Cell DTX indication stops the Inactivity Timer. FIG. 2 at 210 indicates that the UE monitors PDCCH according to an additional C-DRX cycle (a third cycle) upon receiving a Cell DTX indication at 208 to ensure alignment between Cell DTX 212 and C-DRX. The adaptation is shown 210 as a third cycle in response to the Cell DTX information, and corresponds to the interval between On durations on the third line of FIG. 2.

### Additional C-DRX Cycle

The UE may be configured with a separate C-DRX cycle (e.g. a third cycle in addition to the short and long C-DRX cycles, including a different set of C-DRX parameters) to apply only if the serving cell is in activated cell DTX state, i.e. upon reception of a cell DTX activation indication and/or configuration. Upon expiry of the UE C-DRX inactivity timer, the short cycle timer, or upon receiving the DTX activation command, the UE may apply such third cycle. The UE may enter long DRX cycle or the third cycle directly upon reception of indication or configuration activating cell DTX. The UE may not start short DRX timer if it enters the long cycle following a Cell DTX indication or determination.

The UE may be predefined and configured to monitor PDCCH during cell DTX active period, among other DL signals and channels. The UE may not be required to monitor PDCCH during cell DTX inactive period. The UE may be predefined and/or configured whether to monitor RLM, RRM, BFD signals during DTX inactive periods.

The UE may stop the DRX Inactivity timer upon reception of Cell DTX activation indication, if running. Upon reception of L1/L2/PDCCH signaling activating cell DTX (or determining NES), UE may not start C-DRX inactivity timer and may enter C-DRX directly (e.g. the third cycle configured to be used while cell DTX is activated). UE may stop the inactivity timer upon expiry of the cell DTX active period. UE may use an alternative value for DRX inactivity timer associated with cell DTX and another with cell DRX, if cell DTX and/or cell DRX is activated in the serving cell.

The UE may be configured an alternative/different set of C-DRX parameter values to apply (e.g. for the third cycle) if the serving cell has Cell DTX and/or Cell DRX activated (e.g. after the reception of a cell DTX/DRX activation command and before a deactivation command has been received). The parameters may include alternatives values for: drx-onDurationTimer; drx-InactivityTimer; drx-RetransmissionTimerDL; -drx-RetransmissionTimerUL (per UL HARQ process); drx-LongCycleStartOffset drx-StartOffset; drx-ShortCycle; drx-ShortCycleTimer; drx-HARQ-RTT-TimerDL; and/or dix-HARQ-RTT-TimerUL.

### Implicit Adjustment of DRX Cycle Based on Cell DTX

In some solutions, the UE may receive a Cell DTX configuration in addition to its DRX configuration. The UE may then determine when to start the on-duration timer based on at least both DRX configuration and a Cell DTX configuration. Such solutions may allow the network to more dynamically indicate periods of inactivity by using cell-specific, UE-group or UE-specific signaling for indicating parameters of a Cell DTX configuration

### A. Masking of DRX Occasions by Cell DTX Active Period

In a solution, the UE may start the on-duration timer at the beginning of a DRX cycle under a condition that this time is within a Cell DTX active period or within a Cell DTX occasion. For example, the beginning of a DRX cycle may be drx-SlotOffset after the beginning of a subframe satisfying [SFN x 10+subframe number] modulo (drx-LongCycle)=drx-StartOffset, in case a Long DRX cycle is used. Then, the UE may only start the on-duration timer if this time is between the start of a subframe satisfying [SFN x 10+subframe number] modulo (Cell DTX cycle)=(Cell DTX offset) and a time Cell-DTX-duration later. Such solution may be applicable only in case the Cell DTX cycle is longer than the DRX cycle that the UE uses.

### B. Shifting of DRX Occasions to Cell DTX Occasions

In a solution, the UE may start the on-duration timer every M Cell DTX occasions, where M is an integer that may depend on at least the values of the Cell DTX cycle and the DRX cycle that the UE uses. For example, M may correspond to the largest integer that is smaller than the ratio (DRX-cycle/Cell-DTX-cycle). Such solution may be applicable when the DRX cycle that the UE uses is longer than the Cell DTX cycle.

The set of Cell DTX occasions within which the UE may start the on-duration timer may include the set of occasions starting in the following subframe, where K is an integer ranging from 0 to M−1:

$$[ SFN \times 10 + subframe number ] modulo ( M \times Cell - DTX - cycle ) = ( Cell - DTX - offset ) + ( K \times Cell - DTX - cycle )$$

The UE may start the on-duration timer after a time offset Toffset following the start of the Cell DTX occasion, e.g. in a subframe satisfying:

$$[ SFN \times 10 + subframe number ] modulo ( M \times Cell - DTX - cycle ) = ( Cell - DTX - offset ) + ( K \times Cell - DTX - cycle ) + Toffset .$$

The time offset Toffset may be determined to be zero (0) in case the value of the on-duration timer exceeds the duration of the Cell DTX occasion. Otherwise, the time offset may be a value between zero (0) and the difference Tmax_offset between the duration of the Cell DTX occasion (Cell-DTX-duration) and the value of the on-duration timer.

The UE may receive the value of at least one of K and time offset Toffset explicitly by RRC, MAC or DCI signaling. Alternatively, the UE may determine the value of K and/or time offset Toffset implicitly from another configuration aspect such as the RNTI used for receiving PDCCH (e.g. C-RNTI). For example, the time offset may be determined based on the N most (or least) significant bits of the RNTI in units of subframes or slots, where N may be explicitly signaled or determined as a function of Tmax_offset. For example, N may be the highest value such that 2N is lower than Tmax_offset. For example, the value of K may be determined based on the M most (or least) significant bits of the RNTI.

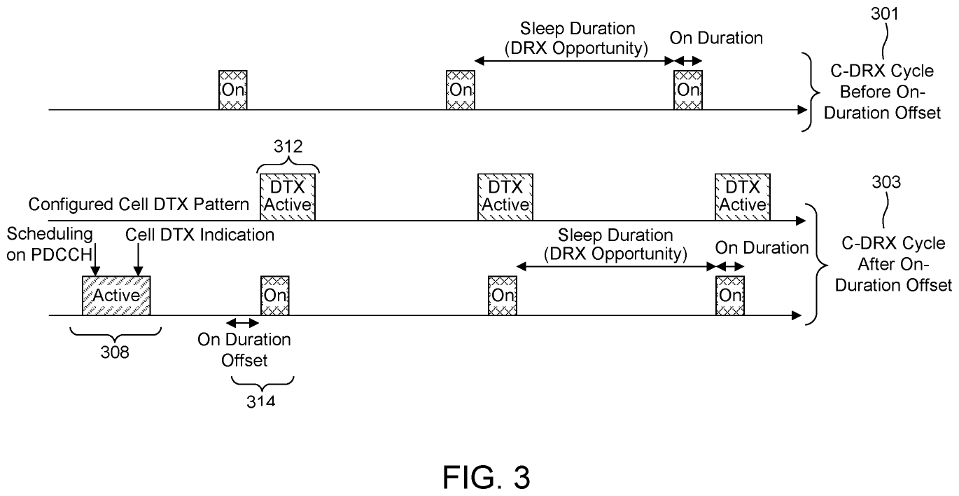

FIG. 3 is a depiction of an adaptation of a time offset of the C-DRX cycle to align C-DRX on duration with periods when the network is in an active state (Cell DTX). The On-Duration offset of FIG. 3 can assist in the FIG. 2 adaptation. In FIG. 3, a C-DRX cycle is shown 301 before a DRX ON-Duration offset is applied according to the disclosure. In the C-DRX Cycle depiction 303, an On-Duration offset is applied 314 in response to receiving a Cell DTX Indication at 308. The On-Duration Offset 314 aligns the DRX On-Duration opportunity to the 312 DTX Active occurrence.

The UE may adapt On duration periods and/or On duration start times if cell DTX is activated. UE may skip an on Duration (i.e. UE is not required to monitor PDCCH during such On Duration) if the C-DRX On Duration not aligned with cell DTX active period (e.g. during a configured Cell DTX inactive period). UE may apply a configured offset or different On Duration period to one or more On Duration if cell DTX active period is not aligned with it in the time domain. UE may apply the offset only to a subset of On Durations that aren't aligned and on during a configured subset of periods.

UE may inform other out of coverage UEs about cell DTX activity over Sidelink (e.g. the configuration of cell DTX/DRX and/or the activation status of a cell DTX/DRX configuration).

FIG. 4 depicts how the UE can adapt operation of a DRX HARQ RTT UL timer to ensure that it can monitor PDCCH for retransmissions while the network is not in an energy saving (sleep) state. A normal C-DRX cycle HARQ timing response is shown at 402. The UE monitors PDCCH for retransmission while the DRX ReTx UL timer is running. This timer starts after the DRX HARQ RTT UL timer expires. If the UE starts the DRX HARQ RTT UL timer as in current specifications shown in 401, it will expire while the network is sleeping and has no opportunity to transmit a PDCCH for a retransmission. Note that the DRX ReTx UL timer at 402 does not occur during a 412 DTX Active opportunity.

For a PUSCH transmission on a CG occasion (CGO) or a DG during a cell DTX inactive period while the UE is in C-DRX, the UE may delay the start of the HARQ RTT timer just prior to the cell DTX active period start (with sufficient time), such that the start of the UL DRX retransmission timer is aligned with the start of the Cell DTX active period. This is shown as the timing of 404. Alternatively, after the expiry of the DRX UL HARQ RTT timer, UE may delay the start of the DRX Retransmission-UL timer until the cell DTX active period starts as shown in 406. Alternatively, the UE may prolong the Re-Tx timer until the next cell DTX active period elapses, over multiple DTX active periods, and/or UE may use an alternative configured value for the retransmission timer if the PUSCH was transmitted during cell DTX inactive period. The UE may stop the drx-retransmission timer if the cell DTX active period (e.g. on duration) ends while the cell DTX inactive period is ongoing

The UE may be predefined, configured, or specified based on its capacity to prioritize or skip CG transmissions occasions during Cell DRX and/or Cell DTX inactive periods (outside of cell DRX on durations) over cell DRX inactive periods. For example, some UEs may be predefined or configured to not use CG occasions during cell DRX inactive periods and/or cell DTX inactive periods. In another example, a UE may be configured or predefined such that DL/UL CGs grant transmissions may override over configured cell DTX/DRX patterns, possibly on a subset of configured grant occasions.

In one method, if cell DTX is activated and the UE is in C-DRX, UE may select the CG occasion for PUSCH transmission such that DRX UL retransmission timer is aligned with DTX active period from the set of available next CG occasions.

Following a DG transmission during Cell DTX inactive period, the UE may delay the start of the UL HARQ RTT timer just prior to the next DTX active period such that the drx-retransmission timer is aligned with the DTX active period. The UE may alternatively delay the start of the drx-retransmission timer until the cell DTX on duration starts.

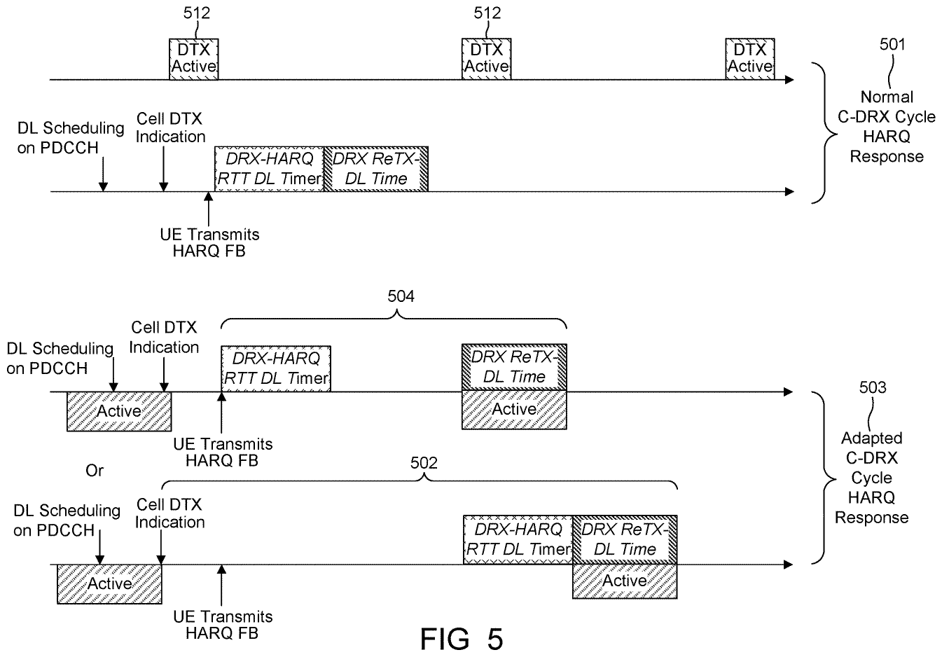

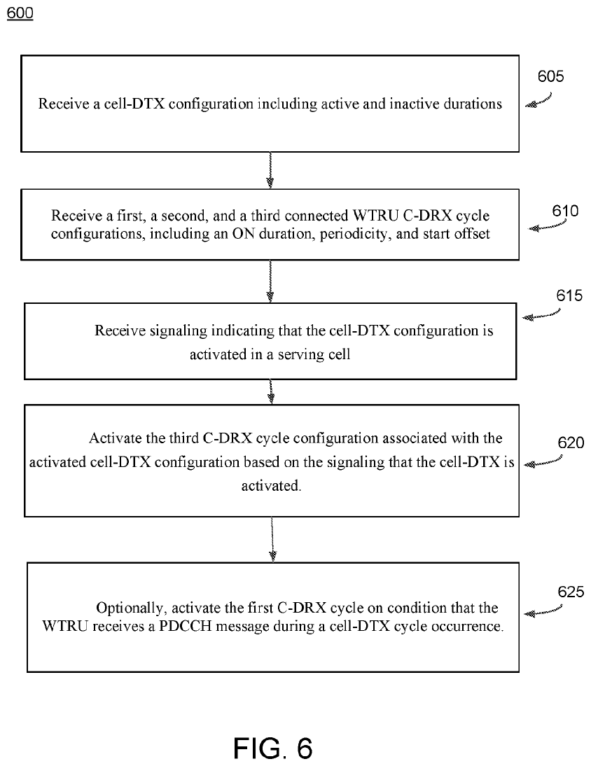

FIG. 5 depicts how the UE can adapt operation of a DRX HARQ RTT DL timer to ensure that it can monitor PDCCH for retransmissions while the network is not in an energy saving (sleep) state. The FIG. 5 timing depiction can assist the adaptation timing shown in FIG. 4. The UE monitors PDCCH for retransmission while the DRX ReTx DL timer is running. This timer starts after the DRX HARQ RTT DL timer expires as shown in the normal C-DRX cycle HARQ response 501. If the UE starts the DRX HARQ RTT DL timer as in current specifications, it will expire while the network is sleeping and has no opportunity to transmit a PDCCH for a retransmission.

In legacy NR protocol, the UE starts DL HARQ RTT timer after transmitting HARQ feedback on PUCCH for the DL TB. In one method, the UE may start the timer just prior to the next DTX active period such that the DRX-DL retransmission timer is aligned with the cell 512 DTX active period as shown in the timing of 502. Alternatively, after the expiry of the DRX DL HARQ RTT timer, UE may delay the start of the DRX Retransmission-DL timer until the cell DTX active period starts as in 504. Alternatively, the UE may prolong the DL Re-Tx timer until the next cell DTX active period elapses, over multiple DTX active periods, and/or UE may use an alternative configured value for the retransmission timer if the PUSCH was transmitted during cell DTX inactive period. The UE may stop the DRX-retransmission timer if the cell DTX active period (e.g. on duration) ends while the cell DTX inactive period is ongoing.

In one example embodiment, a method as described above in the section entitled “Adaptation of UE C-DRX with Cell DTX/DRX” may include the features of following steps:
1. UE is configured with a Cell DTX and Cell DRX configurations, including active vs. inactive durations.
2. UE is configured with a first C-DRX cycle, including ON duration, periodicity, and start offset. The first C-DRX cycle may be one or more of a short C-DRX cycle or a long DRX cycle.
3. UE is configured with an additional second (i.e. a third) UE-specific C-DRX cycle applicable while a cell DTX configuration is activated, in addition to the first C-DRX cycle.
4. UE receives signaling indicating that Cell DTX and/or Cell DRX is activated in the serving cell.
5 UE activates the second C-DRX cycle associated with the activated cell DTX configuration.
6. If UE receives a PDCCH during the Cell DTX cycle, the UE activates the first UE specific C-DRX cycle.

FIG. 6 is a flow diagram addressing an example method 600 of wireless transmit/receive unit (WTRU) C-DRX with a cell DTX/DRX. The method 600 may be performed by a WTRU. At 605, the WTRU receives a cell-DTX configuration including active and inactive durations for the received cell-DTX configuration.

At 610, the WTRU receives a first, a second, and a third C-DRX cycle configurations, including an ON duration, periodicity, and start offset. At 615, the WTRU receives signaling indicating that the cell-DTX configuration is activated in a serving cell of the WTRU

At 620, the WTRU activates the third C-DRX cycle configuration associated with the activated cell-DTX configuration based on the signaling that the cell-DTX has been activated.

Optionally, possibly at a later time, at 625, the WTRU may activate the first C-DRX cycle on condition that the WTRU receives a physical downlink control channel (PDCCH) message during a cell-DTX cycle occurrence.

Adaptation of L1 PDCCH Monitoring with Cell DTX

### DCP—DL WUS

A UE may skip monitoring for DCP occasions that don't overlap with cell DTX active period.

In another method, a UE may be configured whether to monitor or skip monitoring a wake-up signal (e.g., the DCP) when the WUS occasion overlaps with the cell DTX inactive time.

The WUS may indicate to the UE whether to wake-up if the DRX On duration of the UE overlaps fully and/or partially with the cell DTX Inactive time.

A signal may be sent by the gNB and the signal may indicate go-to-sleep for the gNB for a specific DTX Active time and/or a DRX Active time. A UE receiving the go-to-sleep indication may expect that the cell will be in sleep state in specific DTX Active time (i.e., at least some channels/signals will not be transmitted by the cell) and/or the cell will be in sleep state in specific DRX Active time (i.e., at least some channels/signals will not be received by the cell)

### CSI Reporting During C-DRX

Currently, a UE reports periodic L1-RSRP or CSI on PUCCH if configured and DCP (DL WUS) not received. Instead, UE may not report other periodic CSI or L1-RSRP if DCP not received, and the serving cell has a cell DRX activated.

CSI could be outdated if measurements lag the reporting. UE may measure the samples closer to the cell DRX active time when reporting CSI, e.g. during specific cell DTX on durations or x ms prior to the cell DRX active period during which the UE reports the CSI.

The reception of a cell DTX and/or cell DRX indication may override a previously received MAC CE indicating activation or a request for semi-persistent and aperiodic CSI measurement and reporting. The overriding may cancel the reporting, delay it, or re-align it with cell DRX configuration.

The UE may be configured to drop and/or may drop a CSI report if one or more of the following conditions hold.
1. The time occasion of the CSI report may overlap with the cell DRX inactive time, e.g., the cell may be in sleep mode and may not receive an uplink transmission.
2. The CSI-RS resource(s) corresponding to the CSI report (i.e., the resources that may be used to derive the report) is not transmitted by the cell. For example, the cell may not transmit the CSI-RS due to being in DTX Inactive state.
3. The CSI-RS resource(s) that may be used to derive the CSI report may have been transmitted by the cell outside a time window. In one method, if the earliest CSI-RS transmission occasion that may be used to derive the CSI report is within a time interval with respect to the time occasion of the CSI report, then the CSI report may be sent; otherwise, the report may be dropped. For example, if the report is to be transmitted in slot n and the CSI-RS occasion is in slot n-t, and t is greater than a configured threshold value t_ths, then the report may be dropped. The time unit of the configured value may be in slots, ms, etc.

The UE may be indicated whether to drop or transmit a CSI report while the cell is in DRX Inactive state. The indication may be by configuration or other signaling such as a MAC CE and/or L1 signaling. The UE may determine to drop or transmit the CSI report based on at least one of the following:
1. CSI report configuration: A CSI report configuration may include whether the report may be dropped. For example, for CSI report config #1, the UE may be configured to drop the report and for CSI report config #2 the UE may be configured to send the report.
2. CSI report configuration quantity. For example, the UE may be expected to send the report if the reporting quantity includes RSRP and/or SINR and drop the report otherwise.
3. CSI report configuration type. For example, the UE may be configured to drop the report if the type is periodic or semi-persistent and send the report if the type is aperiodic.
4. The corresponding CSI-RS resources. For example, the UE may send the report of the CSI-RS resource is SSB and drop the report otherwise.
5. Whether the corresponding CSI resource has been transmitted by the cell or not.

The UE may expect to receive transmission of a CSI resource when the cell is in DTX Inactive state. The UE may determine to receive a CSI resource based on at least one of the following.
1. CSI resource configuration. A CSI resource configuration may include whether the CSI-RS may be transmitted by the cell.
2. CSI resource (e.g., whether the resource is for channel measurement or interference measurement; or whether the resource is SSB or CSI-RS).
3. Associated CSI report. The CSI-RS may be transmitted if there is an associated report to be sent by the UE.
4. CSI resource type (e.g., whether the resource is periodic, semi-static or aperiodic).

In one method, the UE may request the cell for the transmission of a CSI-RS. The UE may be configured with a list of CSI-RS resource configurations. The CSI-RS resource may be an aperiodic resource. The UE may request the gNB to transmit the CSI-RS corresponding to one of the resource configurations. The timing of the CSI-RS transmission may be configured and/or indicated by the UE. For example, the timing may be an offset to the slot in which the request is sent. The UE may be expected to send a CSI report corresponding to the requested CSI-RS. For example, the requested CSI-RS may be NZP CSI-RS and the corresponding report may include CRI and RSRP. The UE may be configured with a list of triggering states and each triggering state may include the CSI-RS and/or CSI report configurations. The UE may indicate a triggering state in the request.

The resources for the CSI-RS request may be configured. As an example, the request may be sent in PUCCH and the PUCCH resource may be in a slot in which the cell is expected to be in DRX Active mode. For example, the UE may send the request in the first slot after of the DRX Active state after the cell being in DRX Inactive state. The request may be sent in a MAC CE. The cell may send a DCI with a CSI report request field that indicates a configured report. The indication may also include to use the requested CSI-RS to derive the report. In another method, the UE may use the requested CSI-RS to derive a periodic or a semi-persistent report.

In one method, the cell may indicate to skip transmission of all signals/channels or a subset of signals/channels while the cell is in DTX Active time. The indication may be sent in a L1 signal (e.g., the PDCCH) or a MAC CE. A UE receiving the indication may not expect to receive any signal/channel that is not to be transmitted during the skipping duration. In another method, the cell may indicate to skip reception of all signals/channels or a subset of signals/channels while the cell is in DRX Active time. The indication may be sent in a L1 signal (e.g., the PDCCH) or a MAC CE. A UE receiving the indication may not expect to transmit any signal/channel that is not to be received during the skipping duration. In another method, the cell may indicate skipping transmission and/or reception in the same signal. When L1 signaling is used, the DCI may contain at least one codepoint. A codepoint may indicate a duration during which the transmission skipping will be performed, or a duration during which a reception skipping will be performed, or a pair of durations one for transmission and one for reception, or a duration during which transmission and reception skipping will be performed.

During a DTX Active time, e.g., in the last slot of the DTX Active time, a cell may indicate to a UE whether the DTX Active time may be extended. The indication may include the time duration of the extension. L1 signaling may be used for the indication. For example, with two bits, the following may be indicated: 00: no extension; 01: extend by x ms/slots; 10: extend by y ms/slots; 11: extend until the start of the next Active time. A short DTX cycle may be configured wherein the short DTX cycle may run between the Active times of a long DTX cycle. The short DTX cycle may be activated/deactivated dynamically. During a DTX Active time, the cell may indicate whether the short DTX cycle will run, for example, until the next Active time of the long DTX cycle. In one method, the short DTX cycle may stay active until it is deactivated or until a timer expires. A short DTX cycle may be activated when it is configured for a UE. More than one DTX cycles (e.g., short DTX cycle) may be configured and one of them may be activated.

### PDCCH Skipping

UE may adapt PDCCH skipping according to cell DTX inactive period. UE can be semi-statically configured to activate PDCCH skipping per DTX config during inactive periods. The UE may use a different set of values when cell DTX is activated. if cell DTX is active, UE can use a different DCI/PDCCH skipping table for example.

Currently, UE skips PDCCH control search space for either a certain duration or until they receive further indication to activate back PDCCH monitoring. With cell DTX, the UE may autonomously activate regular monitoring when cell DTX goes into active. UE can autonomously deactivate it (apply skipping) upon determining cell DTX is inactive.

If the UE receives PDCCH skipping indication, depending on HARQ FB outcome, gNB could still assign re-tx until TB succeeds. The UE may monitor PDCCH even after receiving a PDCCH skipping indication if a NACK is determined or signaled.

### Search Space Switching

UE may switch search spaces but only at the DTX active periods. UE can be configured with a search space(s) to monitor per cell DTX configuration, e.g. to be monitored when cell DTX is active. A search space group can be adapted according to whether cell DTX is active or not.

### Additional Embodiment

In another/different embodiment of the disclosure, a method performed by a WTRU may include an adaptation of a SR transmission in a cell. In such a method, the WTRU receives a configuration of one or more logical channels (LCH)s, wherein each LCH is associated with a first scheduling request (SR) configuration or a second SR configuration. The WTRU receives one or more of a cell discontinuous transmission (cell-DTX) configuration and a cell discontinuous receive (cell-DRX) configuration for a serving cell. The WTRU transmits a SR to the serving cell with a first LCH of the one or more LCHs. The WTRU can then exercise options based on conditions.

In one option, on condition that the first SR configuration is associated with the first LCH, the WTRU transmits a first SR on a first physical uplink control channel (PUCCH) occasion of the first SR configuration that occurs during a first cell DRX active duration. Also if an uplink (UL) grant is not received after at least one cell DTX active duration has occurred after the first SR transmission, the WTRU transmits a second SR on a second PUCCH occasion of the first SR configuration that occurs during a second cell DRX active duration.

In another option, on condition that the second SR configuration is associated with the first LCH, the WTRU transmits the first SR on a first PUCCH occasion of the second SR configuration independently of the cell DRX active duration. Also, if an UL grant is not received, the WTRU transmits the second SR on a second PUCCH occasion of the second SR configuration independently of the cell DRX active duration.

In the above embodiment, the method may also include the feature that the cell-DTX configuration includes a transmission active period and a transmission inactive period of the serving cell, and the cell-DRX configuration comprises a reception active period and a reception inactive period of the serving cell.

In the above embodiment, the method may also include the feature that WTRU using the second SR configuration triggers a new SR even if the WTRU has an available uplink (UL) grant and if the available grants are time-overlapping with the cell-DRX inactive period.

In the above embodiment, the method may also include the feature that the WTRU using the second SR configuration monitors a physical downlink control channel (PDCCH) while any SR is pending even if the cell-DTX pattern is in the inactive period.

In the above embodiment, the method may also include the additional step of on condition that a pending buffer status report/scheduling request (BSR/SR) is multiplexed on a physical uplink shared channel (PUSCH) payload, the WTRU cancels the BSR/SR if the transmitted payload occurred during a cell-DRX active period, an ACK is received, or reference received power (RSRP) is measured to be greater than a threshold value.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A wireless transmit/receive unit (WTRU) comprising:
processor circuitry; and
a transceiver coupled with the processor circuitry, wherein the processor circuitry and the transceiver are configured to:
receive a cell discontinuous transmission (cell-DTX) configuration including active and inactive durations for the cell-DTX;
receive a cell discontinuous receive (cell-DRX) configuration including active and inactive durations for the cell-DRX;
receive a first, a second, and a third connected WTRU DRX (C-DRX) cycle configuration, wherein each C-DRX cycle configuration includes at least one of: an ON duration, a periodicity, or a start offset of a respective C-DRX cycle;
receive signaling indicating that at least one of the cell-DTX configuration or the cell-DRX cell configuration is activated in a serving cell of the WTRU; and
activate the third C-DRX cycle configuration, wherein the third C-DRX cycle configuration comprises information associated with an activated cell-DTX configuration or an activated cell-DRX based on the signaling indicating that the least one of the cell-DTX or the cell-DRX cell configuration is activated.

2. The WTRU of claim 1, wherein the first C-DRX cycle configuration comprises information indicating one of a short C-DRX cycle or a long C-DRX cycle, and wherein the second C-DRX cycle configuration comprises a remaining cycle configuration.

3. The WTRU of claim 1, wherein the processor circuitry is further configured to: activate the third C-DRX configuration based on any one of expiry of a WTRU C-DRX inactivity timer, a short cycle timer, or upon receiving a DTX activation command.

4. The WTRU of claim 1, wherein the third C-DRX configuration is associated with the cell-DTX configuration.

5. The WTRU of claim 1, wherein the processor circuitry is further configured to:
activate the first C-DRX cycle configuration on a condition that the WTRU receives a physical downlink control channel (PDCCH) message during a cell-DTX cycle occurrence.

6. The WTRU of claim 1, wherein the processor circuitry is configured to skip a C-DRX on-duration period occurrence if the C-DRX on-duration occurrence is not aligned with an active period of the cell-DTX configuration.

7. A method performed by a wireless transmit/receive unit (WTRU), the method comprising:
receiving a cell discontinuous transmission (cell-DTX) configuration including active and inactive durations for the cell-DTX configuration;
receive a cell discontinuous receive (cell-DRX) configuration including active and inactive durations for the cell-DRX;
receiving a first, a second, and a third connected WTRU DRX (C-DRX) cycle configuration, wherein each C-DRX cycle configuration includes at least one of: an ON duration, a periodicity, or a start offset of a respective C-DRX cycle;
receiving signaling indicating that at least one of the cell-DTX configuration or the Cell-DRX cell configuration is activated in a serving cell of the WTRU; and
activating the third C-DRX cycle configuration, wherein the third C-DRX cycle configuration comprises information associated with an activated cell-DTX configuration or an activated cell-DRX based on the signaling indicating that at least one of the cell-DTX configuration or the Cell-DRX cell configuration is activated.

8. The method of claim 7, wherein the first C-DRX cycle configuration comprises information indicating one of a short C-DRX cycle configuration or a long C-DRX cycle configuration, and wherein the second C-DRX cycle configuration comprises a remaining cycle configuration.

9. The method of claim 7, wherein activating the third C-DRX cycle configuration is based on any one of expiry of a WTRU C-DRX inactivity timer, a short cycle timer, or upon receiving a DTX activation command.

10. The method of claim 7, wherein the third C-DRX cycle configuration is associated with the cell-DTX configuration.

11. The method of claim 7, further comprising:
activating the first C-DRX cycle configuration on a condition that the WTRU receives a physical downlink control channel (PDCCH) message during a cell-DTX cycle occurrence.

12. The method of claim 7, further comprising skipping a C-DRX on-duration period occurrence if the C-DRX on-duration occurrence is not aligned with an active period of the cell-DTX configuration.

13. A non-transient computer-readable storage media having instructions therein, wherein when executed by a computer, perform a method of:
receiving a cell discontinuous transmission (cell-DTX) configuration including active and inactive durations for the cell-DTX configuration;
receive a cell discontinuous receive (cell-DRX) configuration including active and inactive durations for the cell-DRX;
receiving a first, a second, and a third connected WTRU DRX (C-DRX) cycle configuration, wherein each C-DRX cycle configuration includes at least one of: an ON duration, a periodicity, or a start offset of a respective C-DRX cycle;
receiving signaling indicating that at least one of the cell-DTX configuration or the Cell-DRX cell configuration is activated in a serving cell of the WTRU; and activating the third C-DRX cycle configuration, wherein the third C-DRX cycle configuration comprises information associated with an activated cell-DTX configuration or an activated cell-DRX based on the signaling indicating that at least one of the cell-DTX configuration or the Cell-DRX cell configuration is activated.

14. The WTRU of claim 1, wherein the third C-DRX configuration further comprises information indicating least one of: a drx-onDurationTimer, a drx-InactivityTimer, a drx-RetransmissionTimerDL, a drx-RetransmissionTimerUL, a drx-LongCycleStartOffset, a drx-StartOffset, a drx-ShortCycle, a drx-ShortCycleTimer, a drx-HARQ-RTT-TimerDL, or drx-HARQ-RTT-TimerUL.

15. The method of claim 7, wherein the third C-DRX cycle configuration further comprises information indicating least one of: a drx-onDurationTimer, a drx-InactivityTimer, a drx-RetransmissionTimerDL, a drx-RetransmissionTimerUL, a drx-LongCycleStartOffset, a drx-StartOffset, a drx-ShortCycle, a drx-ShortCycleTimer, a drx-HARQ-RTT-TimerDL, or drx-HARQ-RTT-TimerUL.
